(19) United States
(12) Patent Application Publication
(10) Pub. No.: US 2007/0029429 A1
(43) Pub. Date: Feb. 8, 2007

(54) Seatbelt retractor

(75) Inventor: Yasuaki Nomura, Tokyo (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/496,571

(22) Filed: Aug. 1, 2006

(30) Foreign Application Priority Data
Aug. 4, 2005 (JP) 2005-226389

(51) Int. Cl. B60R 22/44

(52) U.S. Cl. 242/374

(57) ABSTRACT

A seatbelt retractor is configured such that the thickness of the base end of a seatbelt in engagement with a spool is minimized so as to reduce the outside diameter of the spool so that the size can be reduced effectively and high workability can be provided. A spool includes a spool body and a cylindrical member placed in the spool body. The spool body has an arc-shaped body. With the cylindrical member placed in the spool body, the interval between the inner circumferential surface of the body and the outer circumferential surface of the cylindrical member is set substantially the same as the thickness of the seatbelt. The base end of the seatbelt sandwiched between the body and the cylindrical member in such a manner that an end of the seatbelt is folded back is in engagement with the rim of the body.

### BACKGROUND

The present invention relates to a seatbelt retractor and a seatbelt system having the same installed in vehicles, such as cars, in which the retractor retracts and withdraws the seatbelts with spools and is used for restraining occupants with seatbelts to protect the occupants.

Seatbelt systems installed in vehicles restrain occupants with seatbelts in an emergency in which high deceleration is applied to vehicles, such as in a vehicle crash, to prevent the inertial movement of the occupants from seats, thereby protecting the occupants. The seatbelt systems have a seatbelt retractor that retracts and withdraws a seatbelt with a spool and prevents the withdrawal of the seatbelt in an emergency.

For such seatbelt retractors, a seatbelt retractor is disclosed which retracts and withdraws a seatbelt with a motor in, for example, PCT Japanese Translation Patent Publication No. 2003-507252 (JP Pub. No. '252), which is incorporated by reference herein in its entirety. The seatbelt retractor disclosed in JP Pub. No. '252 is such that an electric motor is disposed in series coaxially with a belt reel (hereinafter, also referred to as a spool) on one axial side of the belt reel, in which the rotation of the electric motor is transmitted to the belt reel while being reduced in speed by a reduction mechanism having a planetary reduction gear mechanism. As the belt reel is rotated by the rotation of the electric motor in a belt retracting direction or a belt withdrawing direction, the seatbelt is retracted by or withdrawn from the belt reel.

In general seatbelt retractors (including the seatbelt retractor disclosed in JP Pub. No. '252), a seatbelt b passes through a through hole d, which passes through the body c of a spool a (a portion to retract the seatbelt b), and the base end e of the seatbelt b is in engagement with the body of the spool a, as shown in FIG. 8. In this case, the base end e of the seatbelt b in engagement with the spool a is formed in such a manner that an end g of the seatbelt b is folded so as to surround a shaft member f having a specified thickness, such as a pin, to be tightly piled up on an opposing portion h of the seatbelt b, which is then stitched up. Accordingly, the base end e of the seatbelt b becomes massive to increase in thickness.

However, in order to bring this massive and thick base end e into engagement with the body c, the portion of the through hole d for accommodating the base end e (the length of the through hole d in the radial direction of the body c) must be set high to some extent. Also, since the portion where the end g of the seatbelt b is closely piled on the opposing portion h of the seatbelt b must be accommodated in the through hole d, this portion of the through hole d also must be high to some extent.

Therefore, the outside diameter of the spool a must be large. However, the large outside diameter of the spool a causes the size of the spool a to be large, thus posing the problem of increasing the size of the seatbelt retractor. Particularly, for seatbelt retractors driven by a motor, the motor may be accommodated in the spool a having a cylindrical shape to reduce the size of the seatbelt retractor. In this case, however, the increasing of the outside diameter of the spool limits the ability to reduce the size of the seatbelt retractor.

Furthermore, the seatbelt b must be inserted into the long through hole d to bring the seatbelt b into engagement with the spool a, thus resulting in low workability.

### SUMMARY

One embodiment of the invention relates to a seatbelt retractor. The seatbelt retractor comprises a spool for retracting and withdrawing a seatbelt, the spool including: a spool body in a cylindrical shape for retracting the seatbelt; and a cylindrical member placed in the spool body. The spool body has an arc-shaped body; the diameter of the inner circumference of the arc-shaped body is set larger than the outside diameter of the cylindrical member; and a first interval between the inner circumferential surface of the arc-shaped body and the outer circumferential surface of the cylindrical member is set substantially the same as the thickness of the seatbelt, with the cylindrical member placed in the spool body. The base end of the seatbelt retained in the spool is formed in such a manner that an end of the seatbelt is folded back and the entire folded portion is in close contact with an opposing portion of the seatbelt. The seatbelt is sandwiched between the inner circumferential surface of the arc-shaped body and the outer circumferential surface of the cylindrical member; and the base end of the seatbelt is in engagement with a rim of the arc-shaped body.

Another embodiment of the invention relates to a seatbelt system. The seatbelt system comprises a seatbelt for restraining an occupant, a seatbelt retractor for retracting the seatbelt, a tongue slidably supported by the seatbelt and a disengageable buckle to be engaged with the tongue. The seatbelt retractor comprises a spool for retracting and withdrawing a seatbelt. The spool including a spool body in a cylindrical shape for retracting the seatbelt and a cylindrical member placed in the spool body. The spool body has an arc-shaped body; the diameter of the inner circumference of the body is set larger than the outside diameter of the cylindrical member; and a first interval between the inner circumferential surface of the body and the outer circumferential surface of the cylindrical member is set substantially the same as the thickness of the seatbelt, with the cylindrical member placed in the spool body. The base end of the seatbelt retained in the spool is formed in such a manner that an end of the seatbelt is folded back and the entire folded portion is in close contact with an opposing portion of the seatbelt. The seatbelt is sandwiched between the inner circumferential surface of the body and the outer circumferential surface of the cylindrical member; and the base end of the seatbelt is in engagement with a rim of the body.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a schematic diagram of a seatbelt system having a seatbelt retractor according to an embodiment of the invention.

FIG. 2 is a schematic fragmentary sectional view of a seatbelt retractor for use in the seatbelt system shown in FIG. 1.

FIG. 3 is a cross-sectional view taken along line III-III of FIG. 2.

FIGS. 4(a) and 4(b) show a spool body, wherein FIG. 4(a) is a front view and FIG. 4(b) is a cross-sectional view taken along line IVB-IVB of FIG. 4(a).

FIGS. 5(a) and 5(b) show the cylindrical member of FIG. 2, wherein FIG. 5(a) is a front view and FIG. 5(b) is a left side view.

FIG. 6 is a cross-sectional view taken along line VI-VI of FIG. 2.

FIG. 7 is a diagram illustrating the comparison between the sizes of the spool of the invention and a known spool.

FIG. 8 is a cross-sectional view of the known spool.

### DETAILED DESCRIPTION

It is an object of the invention to provide a seatbelt retractor in which the thickness of the base end of a seatbelt retained by a spool is minimized so as to reduce the outside diameter of the spool so that the size can be reduced and high workability is provided.

It is another object of the invention to provide a seatbelt system in which the seatbelt retractor is made compact so that the retractor is highly flexible in where it is located in the vehicle.

A seatbelt retractor according to a first embodiment, which has at least a spool for retracting and withdrawing a seatbelt, is characterized in that the spool comprises a spool body in a cylindrical shape for retracting the seatbelt; and a cylindrical member placed in the spool body; the spool body has an arc-shaped body; the diameter of the inner circumference of the body is set larger than the outside diameter of the cylindrical member; and the interval between the inner circumferential surface of the body and the outer circumferential surface of the cylindrical member is set substantially the same as the thickness of the seatbelt, with the cylindrical member placed in the spool body; the base end of the seatbelt retained in the spool is formed in such a manner that an end of the seatbelt is folded back and the entire folded portion is in close contact with the opposing portion of the seatbelt; and the seatbelt is sandwiched between the inner circumferential surface of the body and the outer circumferential surface of the cylindrical member; and the base end of the seatbelt is in engagement with the rim of the body.

A seatbelt retractor of a second embodiment is characterized in that the folded portion at the base end of the seatbelt is disposed on the side of the cylindrical member.

A seatbelt retractor of a third embodiment is characterized in that a motor for rotating the spool is housed in the cylindrical member.

A seatbelt system of the invention according to a fourth embodiment, which includes a seatbelt for restraining an occupant; a seatbelt retractor for withdrawably retracting the seatbelt; a tongue slidably supported by the seatbelt; and a disengageable buckle to be engaged with the tongue. The seatbelt retractor is the seatbelt retractor according to one of any one of the above embodiments.

With the seatbelt retractor of embodiments of the invention, the spool is configured of two members: a spool body having an arc-shaped body; and a cylindrical member placed in the spool body and having a space substantially the same as the thickness of the seatbelt between the outer circumferential surface of the cylindrical member and the inner circumferential surface of the body. The seat belt is sandwiched between the inner circumferential surface of the body and the outer circumferential surface of the cylindrical member; and the base end of the seatbelt is in engagement with the rim of the body in such a manner that the end of the seatbelt is folded back and the folded portion is in close contact with the opposing portion of the seatbelt. This arrangement enables the base end of the seatbelt to be in tight engagement with the spool.

Since the base end of the seatbelt, which is retained by the spool, is formed in such a manner that one end of the seatbelt is simply folded back and the folded portion is in close contact with the opposing portion of the seatbelt, the base end can be as thin as about twice the thickness of the seatbelt. Accordingly, the diameter of the body of the spool, or the diameter of the belt retracting portion, can be small. Thus, as the outside diameter of the spool is reduced, the entire seatbelt retractor can be made compact correspondingly.

Furthermore, the seatbelt can be retained in the spool only by insertion of the cylindrical member into the spool body with the seatbelt in contact with the spool body. This arrangement facilitates mounting the seatbelt to the spool, thus providing high workability.

According to the second embodiment, the folded portion at the base end of the seatbelt is disposed on the side of the cylindrical member. Accordingly, even when the base end of the seatbelt comes into engagement with the rim of the body, the folded portion does not come off the opposing portion of the seatbelt, thus ensuring the base end of the seatbelt to be retained in the spool for a long period.

According to the third embodiment, a motor for rotating the spool is housed in the cylindrical member. This housing of the motor in the spool allows the seatbelt retractor to be made compact more effectively.

With the seatbelt system having a seatbelt retractor, according to the fourth embodiment, the seatbelt retractor can be made compact, so that high flexibility of layout in vehicles is provided.

A best mode for carrying out the present invention will be described with reference to the drawings.

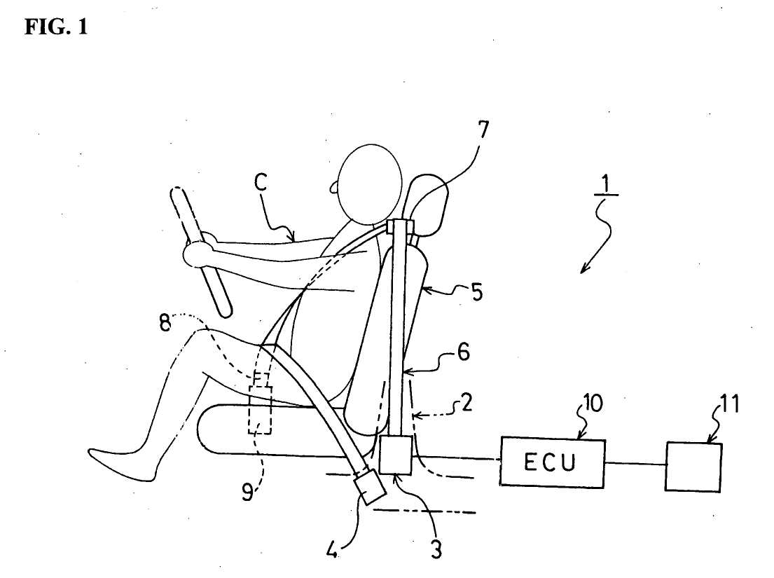

FIG. 1 is a schematic diagram of a seatbelt system having a seatbelt retractor according to an embodiment of the invention. The left and right in the following description denote the left and right in the corresponding diagram used in the description.

Referring to FIG. 1, the seatbelt system 1 includes a seatbelt retractor 3 fixed to a B-pillar 2 or the like of the vehicle body and driven by a motor; a seatbelt 6 withdrawn from the seatbelt retractor 3 and fixed to the floor of the vehicle body or a vehicle seat 5 with a belt anchor 4 at the end; a guide anchor 7 disposed to the vehicle body such as a center pillar, for guiding the seatbelt 6 withdrawn from the seatbelt retractor 3 toward a shoulder of an occupant C; a tongue 8 that is slidably supported by the seatbelt 6 guided from the guide anchor 7; a buckle 9 fixed to the floor of the vehicle body or the vehicle seat 5 and, into which the tongue 8 is detachably inserted; an electronic control unit (ECU) for controlling the driving of the motor of the seatbelt retractor 3; and input unit 11, such as collision sensor or object detector, for sending various input signals to the ECU 10 to control the motor.

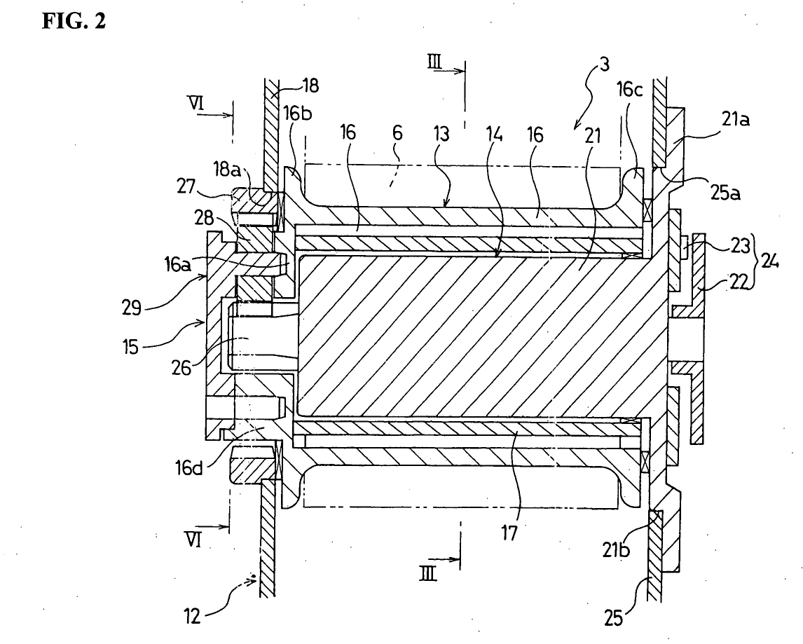

FIG. 2 is a schematic fragmentary sectional view of the seatbelt retractor of the embodiment.

As shown in FIG. 2, the seatbelt retractor 3 includes a base frame 12; a spool 13 for retracting the seatbelt 6; an electric motor 14 for rotating the spool 13; and a reduction mechanism 15 for reducing the torque of the electric motor 14 and transmitting it to the spool 13.

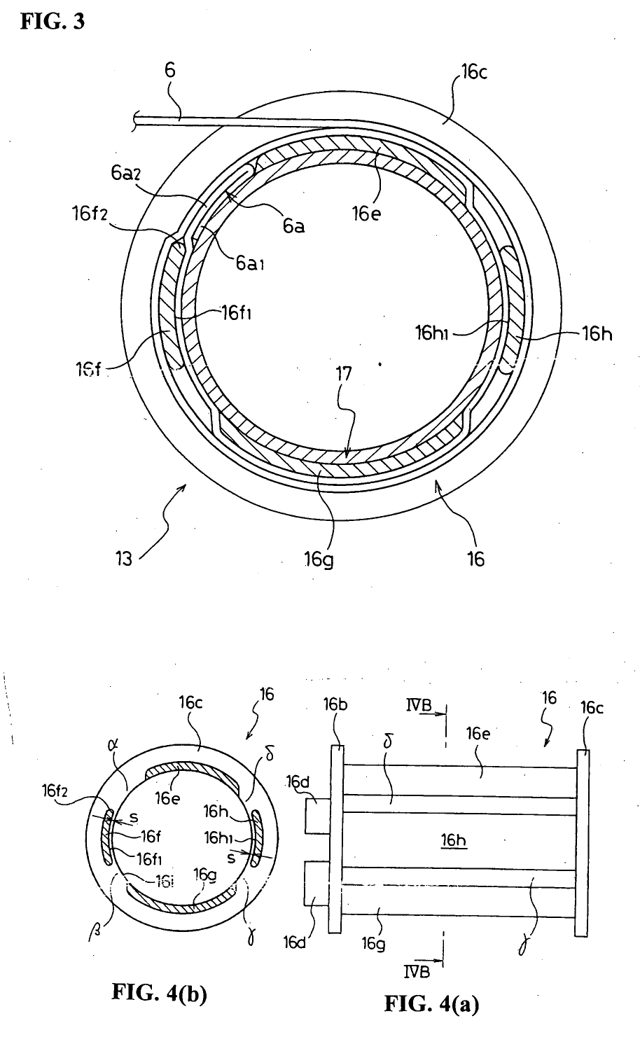

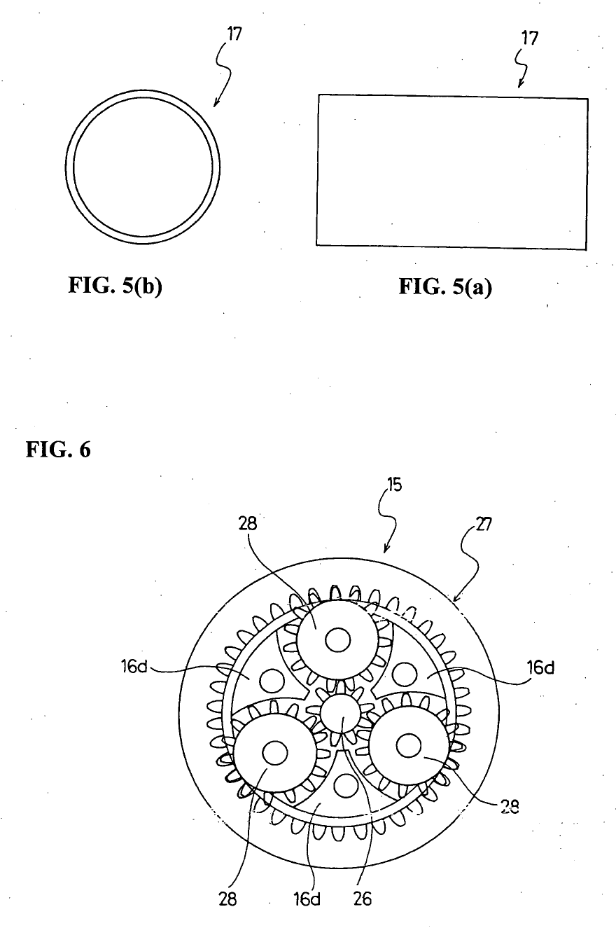

Referring to FIGS. 2 and 3, the spool 13 comprises two members, a spool body 16 and a cylindrical member 17. The spool body 16 has a closed-end cylindrical shape in which the right end is open and the left end has a bottom 16a, and has flanges 16b and 16c at both ends. The bottom 16a has a cylindrical rotating shaft 16d projecting leftward therefrom. The rotating shaft 16d passes through an opening 18a of a first supporting member 18.

Referring then to FIGS. 4(a) and 4(b), the spool body 16 of the spool 13 has first to fourth arc-shaped bodies 16e, 16f, 16g, and 16h that connect the left and right flanges 16b and 16c and for retracting the seatbelt 6. The first and third bodies 16e and 16g are opposed to each other in such a manner that the diameters of the inner circumferential surfaces are the same as the diameter of an inner circumferential hole 16i in the right flange 16c and coaxially with the inner circumferential hole 16i. The width (circumferential length) of the first body 16e is set shorter than the width (circumferential length) of the third body 16g.

The second and fourth bodies 16f and 16h are opposed to each other in such a manner that the diameters of the inner circumferential surfaces 16f₁ and 16h₁ are larger than the diameter of the inner circumferential hole 16i and coaxially with the inner circumferential hole 16i. Accordingly, the respective inner circumferential surfaces 16f₁ and 16h₁ of the second and fourth bodies 16f and 16h are located outside the inner circumferential hole 16i. In this case, the radial distance s between the inner circumferential surfaces 16f₁ and 16h₁ and the inner circumferential hole 16i is set approximately the same as the thickness of the seatbelt 6. The widths (circumferential lengths) of the second and fourth bodies 16f and 16h are set equal.

The first to fourth bodies 16e, 16f, 16g, and 16h are disposed cylindrically with predetermined circumferential intervals α, β, γ, and δ therebetween, respectively. In this case, the circumferential width of the interval a between the first and second bodies 16e and 16f is set at the maximum, and the other three intervals β, γ, and δ are set at the minimum.

The outside diameter of the cylindrical member 17 is set slightly smaller than the diameter of the inner circumferential hole 16i in the right flange 16c, so that it can be fitted in the inner circumferential hole 16i and the first to fourth bodies 16e, 16f, 16g, and 16h which are cylindrically arranged.

The base end 6a of the seatbelt 6 is formed in such a manner that one end of the seatbelt 6 is folded back once; the entire folded portion 6a₁ is in close contact with the opposing portion 6a₂ of the seatbelt 6; and the close contact portion is tightly stitched up. Accordingly, the thickness of the base end 6a is set twice as large as that of the seatbelt 6. The length of the base end 6a along the length of the seatbelt 6 is set shorter than the circumferential length (width) of the interval a by approximately the thickness of the seatbelt 6.

As shown in FIG. 3, the base end 6a of the seatbelt 6 is disposed in the interval a in such a manner that the folded portion 6a₁ is located inside, and the seatbelt 6 extends from the base end 6a along the inner circumferential surface 16f₁ of the second body 16f, then passes through the interval β, extends along the outer circumferential surface of the third body 16g, passes through the interval γ, extends along the inner circumferential surface 16h₁ of the fourth body 16h, passes through the interval δ, and then extends along the external circumferential surface of the first body 16e. In this state, the cylindrical member 17 is inserted from the inner circumferential hole 16i of the flange 16c into the first to fourth bodies 16e, 16f, 16g, and 16h which are disposed cylindrically. With the cylindrical member 17 inserted, the base end 6a is disposed along the outer circumferential surface of the cylindrical member 17, while the seatbelt 6 is sandwiched between the inner circumferential surface 16f₁ of the second body 16f and the outer circumferential surface of the cylindrical member 17 and between the inner circumferential surface 16h₁ of the fourth body 16h and the outer circumferential surface of the cylindrical member 17. The cylindrical member 17 is locked in the spool body 16 in the axial direction with appropriate locking members or fixed to the spool body 16 with appropriate fixing members (not shown).

The interval between the inner circumferential surface 16f₁ of the second body 16f and the outer circumferential surface of the cylindrical member 17 and the interval between the inner circumferential surface 16h, of the fourth body 16h and the outer circumferential surface of the cylindrical member 17 are set at the distance s that is substantially the same as the thickness of the seatbelt 6. Accordingly, with the seatbelt 6 sandwiched between the spool body 16 and the cylindrical member 17, the base end 6a, which is set twice as large as the thickness of the seatbelt 6, is pressed by the rim 16f₂ of the second body 16f into engagement when the seatbelt 6 is drawn. The opposing portion is on the side of the second body 16f. This arrangement prevents the base end 6a from entering the interval between the inner circumferential surface 16f₁ of the second body 16f and the outer circumferential surface of the cylindrical member 17 to pass therethrough. Thus, the base end 6a of the seatbelt 6 is tightly retained in the spool 13. In this case, the folded portion 6a, of the base end 6a is located inside or on the side of the cylindrical member 17, not on the side of the second body 16f. This arrangement prevents the folded portion 6a₁ from coming off the seatbelt 6 which is in close contact therewith, when the base end 6a is pushed against the rim 16f₂ of the second body 16f. One turn of the seatbelt 6 around the spool 13 is wound around the wound seatbelt 6, as with the known spools.

The electric motor 14 is configured as a known inner-rotor brushless motor. The electric motor 14 includes a cylindrical coil stator fixed in a motor housing 21 and a magnetic rotor passing through the stator in the axial direction and rotated by the stator. A magnetic disc 22 is provided on the right side of the rotor. The magnetic disc 22 is rotatable with the rotor, and is housed in the cylindrical member 17 of the spool 13.

A hall sensor 23 is disposed in the motor housing 21. The magnetic disc 22 and the hall sensor 23 configure a rotation amount sensor 24 for measuring the rotation amount of the electric motor 14. The rotation amount sensor 24 is one of the input units 11, which inputs a signal indicative of the rotation amount of the electric motor 14 measured by the rotation amount sensor 24 to the ECU 10.

A mounting flange 21a is formed on the right side of the motor housing 21. The electric motor 14 is inserted axially from the right side into the spool 13, whereby a ring-shaped step 21b of the mounting flange 21a is fitted in an opening 25a of a second support member 25, and the mounting flange 21a is fixed to the second support member 25 with a fixture (not shown).

Referring to FIGS. 2 and 6, the reduction mechanism 15 is configured as a planetary gear reduction mechanism. The planetary gear reduction mechanism includes a sun gear 26 disposed on the left side of the rotor of the electric motor 14 and rotatable with the rotor; an internal gear 27 fixed in the opening 18a of the first supporting member 18; a predetermined number of (three in the example of FIG. 6) planetary gears 28 in engagement with both of the sun gear 26 and the internal gear 27; and a carrier 29 that supports the planetary gears 28 rotatably. The carrier 29 is fixed to the spool 13 so as to rotate with the spool 13. The left end of the spool 13 is radially supported by the sun gear 26 via the carrier 29 and the planetary gears 28. The left end of the spool 13 is rotatably supported by the internal gear 27 via a thrust bearing (numeral thereof is not shown) in the axial direction (in the thrusting direction), while the right end is rotatably supported by the motor housing 21 with a thrust bearing and a radial bearing (numerals thereof are not shown) in the radial direction and the axial direction.

In the seatbelt retractor 3, the rotation of the rotor of the electric motor 14 is transmitted to the planetary gears 28 via the sun gear 26 to rotate the planetary gears 28 on their axes. Then the planetary gears 28 revolve around the sun gear 26 by the rotation, so that the spool 13 rotates via the carrier 29 while reducing speed. In this case, the ECU 10 controls the rotation of the electric motor 14 in response to the rotation amount signal from the rotation amount sensor 24.

Thus, the spool 13 and the electric motor 14 of the seatbelt retractor 3 of the embodiment are directly connected via the reduction mechanism 15, so that the spool 13 rotates with the rotation of the electric motor 14. In this case, when the electric motor 14 is controlled so as to rotate in a forward or reverse direction, the spool 13 rotates in the belt retracting direction or the belt withdrawing direction. The ECU 10 controls the rotation of the electric motor 14 to retract the seatbelt 6 for retraining of the occupant and housing the seatbelt 6 or to assist the withdrawal of the seatbelt 6 for wearing based on the various input signals from the sensors.

The spool 13 of the seatbelt retractor 3 comprises two members: the spool body 16 having the arc-shaped first to fourth bodies 16e, 16f, 16g, and 16h which are disposed cylindrically with circumferential intervals α, β, γ, and δ provided therebetween; and the cylindrical member 17 disposed in the spool body 16 and having a space of about the same size as the thickness of the seatbelt 6 between the outer circumferential surface of the cylindrical member 17 and the inner circumferential surfaces 16f₁ and 16h₁ of the second and fourth bodies 16f and 16h. The seatbelt 6 is sandwiched between the inner circumferential surfaces 16f₁ and 16h₁ of the second and fourth bodies 16f and 16h and the outer circumferential surface of the cylindrical member 17. The end of the seatbelt 6 is folded back, and the folded portion 6a₁ is brought into close contact with the opposing portion 6a₂ of the seatbelt 6; and the closely contact portion is stitched up to form the base end 6a. The base end 6a is in engagement with the rim 16f₂ of the second body 16f. This arrangement enables the base end 6a of the seatbelt 6 to be in tight engagement with the spool 13.

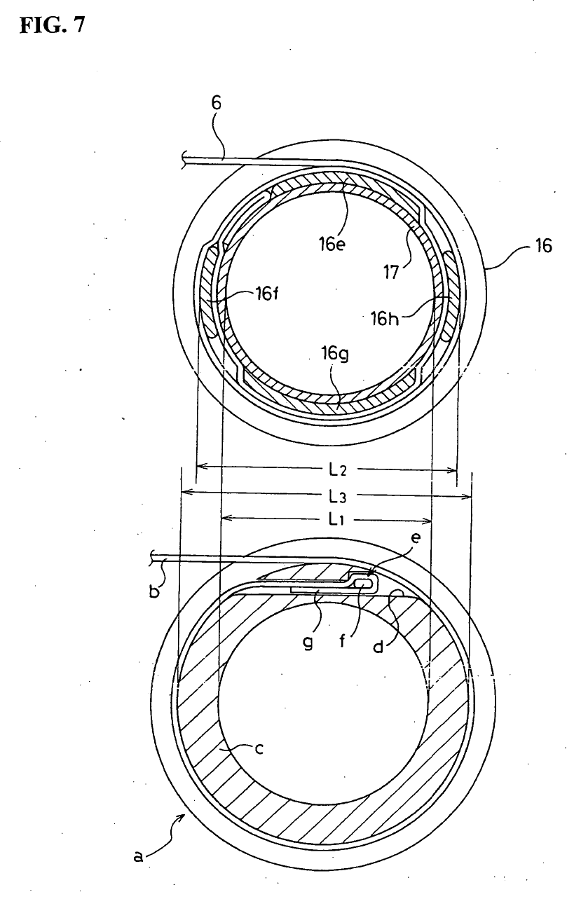

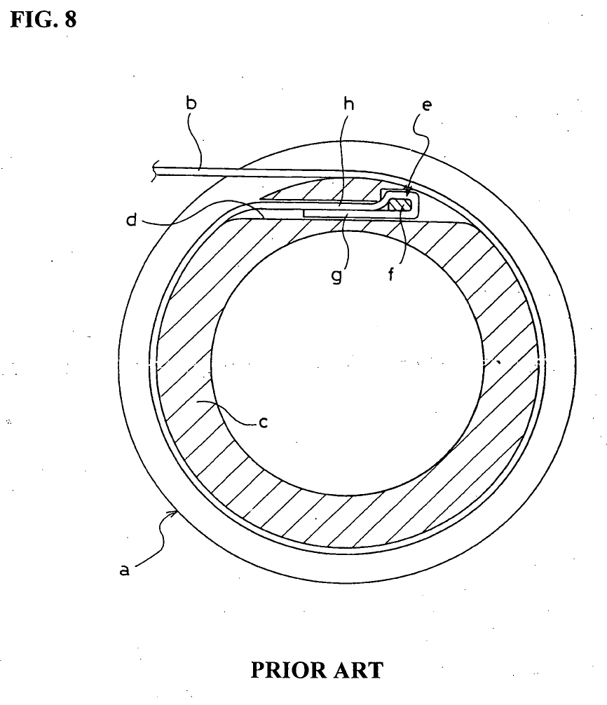

Since the base end 6a of the seatbelt 6 in engagement with the spool 13 is formed in such a manner that one end of the seatbelt 6 is simply folded back and the folded portion 6a₁ is in close contact with the opposing portion 6a₂ of the seatbelt 6, the base end 6a can be as thin as about twice the thickness of the seatbelt 6. Accordingly, the diameter of the belt retracting portion (body) of the spool 13 can be made small. More specifically, assuming that the inside diameter L₁ of the spool 13 (i.e., the inside diameter of the cylindrical member 17) in which the electric motor 14 is housed shown in FIG. 7, and the inside diameter of the known spool shown in FIG. 8 are the same inside diameter L₁ (i.e., when the same electric motor 14 is used), the maximum outside diameter L₂ of the spool 13 can be set smaller than the outside diameter L₃ of the known spool. Thus, as the outside diameter of the spool 13 is reduced, the entire seatbelt retractor 3 can be made compact correspondingly. Particularly, for housing the electric motor 14 in the cylindrical spool 13, the seatbelt retractor 3 can be made compact more effectively.

Furthermore, the seatbelt 6 can be retained in the spool 13 only by insertion of the cylindrical member 17 into the spool body 16 with the seatbelt 6 in contact with the spool body 16. This arrangement facilitates mounting the seatbelt 6 to the spool 13, thus improving workability.

With the seatbelt system 1 having the seatbelt retractor 3 of the embodiment, the seatbelt retractor 3 can be made compact, thereby providing high flexibility of layout in the vehicle.

Although the electric motor 14 of the embodiment is housed in the spool 13, the electric motor 14 may be disposed outside the spool 13 along the axis, like the embodiment in JP Pub. No. '252, or alternatively, may be disposed outside the spool 13 in parallel to the spool 13.

The seatbelt retractor of the invention can be applied to general seatbelt retractors 3 that do not have electric motors 14.

The seatbelt retractor and the seatbelt system according to embodiments of the invention can be applied appropriately to seatbelt retractors for use in seatbelt systems installed in vehicles such as cars, for restraining occupants with seatbelts to protect them, for retracting and withdrawing the seatbelts with spools, and to seatbelt systems having the same.

Japan Priority Application 2005-226389, filed Aug. 4, 2005 including the specification, drawings, claims and abstract, is incorporated herein by reference in its entirety.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A seatbelt retractor comprising:
a spool for retracting and withdrawing a seatbelt, the spool including:
a spool body in a cylindrical shape for retracting the seatbelt; and
a cylindrical member placed in the spool body,
wherein the spool body has an arc-shaped body; the diameter of the inner circumference of the arc-shaped body is set larger than the outside diameter of the cylindrical member; and a first interval between the inner circumferential surface of the arc-shaped body and the outer circumferential surface of the cylindrical member is set substantially the same as the thickness of the seatbelt, with the cylindrical member placed in the spool body;
wherein the base end of the seatbelt retained in the spool is formed in such a manner that an end of the seatbelt is folded back and the entire folded portion is in close contact with an opposing portion of the seatbelt; and
wherein the seatbelt is sandwiched between the inner circumferential surface of the arc-shaped body and the outer circumferential surface of the cylindrical member; and the base end of the seatbelt is in engagement with a rim of the arc-shaped body.

2. The seatbelt retractor according to claim 1, wherein the folded portion at the base end of the seatbelt is disposed on the side of the cylindrical member.

3. The seatbelt retractor according to claim 1, further comprising a motor for rotating the spool, the motor being housed in the cylindrical member.

4. The seatbelt retractor according to claim 1,
wherein the arc-shaped body is a first body, and the retractor further comprises second, third and fourth arc-shaped bodies, and
wherein the circumferential length of the first body is shorter than the circumferential length of the third body opposite the first body.

5. The seatbelt retractor according to claim 4,
wherein the circumferential length of the second and fourth bodies are equal.

6. The seatbelt retractor according to claim 4,
wherein the length of the base end of the seatbelt is shorter than a circumferential interval between the first body and the second body by the thickness of the seatbelt.

7. The seatbelt retractor according to claim 4,
wherein the opposing portion of the seatbelt is disposed on the side of the second body, such that when the base end of the seatbelt is pushed against a rim of the second body, the base end does not pass through the first interval.

8. A seatbelt system comprising:
a seatbelt for restraining an occupant;
a retractor for retracting the seatbelt, wherein the seatbelt retractor comprises a spool for retracting and withdrawing a seatbelt, the spool including: a cylindrically shaped spool body configured to hold the retracted seatbelt; and a cylindrical member located in the spool body;
a tongue slidably supported by the seatbelt; and
a disengageable buckle to be engaged with the tongue,
wherein the spool body includes an arc-shaped body; the diameter of the inner circumference of the arc-shaped body is larger than the outside diameter of the cylindrical member; and wherein a first interval between the inner circumferential surface of the arc-shaped body and the outer circumferential surface of the cylindrical member is substantially the same as the thickness of the seatbelt;
wherein an end of the seatbelt is retained in the spool so that the end of the seatbelt is folded back and the entire folded portion is in close contact with an opposing portion of the seatbelt; and
wherein the seatbelt is sandwiched between the inner circumferential surface of the body and the outer circumferential surface of the cylindrical member; and the end of the seatbelt is in engagement with a rim of the arc-shaped body.

9. The seatbelt system according to claim 8, wherein the folded portion at the end of the seatbelt is disposed on the side of the cylindrical member.

10. The seatbelt system according to claim 8, further comprising a motor for rotating the spool, the motor being housed in the cylindrical member.

11. The seatbelt system according to claim 8, wherein the retractor further comprises second, third and fourth arc-shaped bodies, and wherein the circumferential length of the first mentioned arc-shaped body is shorter than the circumferential length of the third arc-shaped body opposite the first arc-shaped body.

12. The seatbelt system according to claim 11, wherein the circumferential length of the second and fourth arc-shaped bodies are equal.

13. The seatbelt system according to claim 11, wherein the length of the end of the seatbelt is shorter than a circumferential interval between the first arc-shaped body and the second arc-shaped body by the thickness of the seatbelt.

14. The seatbelt system according to claim 11, wherein the opposing portion of the seatbelt is disposed on the side of the second arc-shaped body, so that when the end of the seatbelt is pushed against a rim of the second arc-shaped body, the end does not pass through a space located between the inner circumferential surface of the arc-shaped body and the outer circumferential surface of the cylindrical member.
